(19) United States
(12) Patent Application Publication
(10) Pub. No.: US 2005/0259878 A1
(43) Pub. Date: Nov. 24, 2005

(54) Motion estimation algorithm

(75) Inventors: David Drezner, Raanana (IL); Gideon Kojokaro, Ramat Hasharon (IL)

Correspondence Address: STERNE, KESSLER, GOLDSTEIN & FOX PLLC, 1100 NEW YORK AVENUE, N.W., WASHINGTON, DC, 20005, US

(73) Assignee: Broadcom Corporation, Irvine, CA (US)

(21) Appl. No.: 10/849,442

(22) Filed: May 20, 2004

(51) Int. Cl. G06K 9/36; G06K 9/46

(52) U.S. Cl. 382/236; 382/239

(57) ABSTRACT

The invention refers to an apparatus and a method for determining a motion vector for a current search block, comprising the steps: detecting the correlation between motion vectors determined for previous search blocks; and depending on the detected correlation, either using a first, or a second search region for determining the motion vector for the current search block. The first search region might be located around the center of the current search block, and the second search region might be located around the tip of a motion vector predicted for the current search block on the basis of motion vectors determined for previous search blocks.

### BACKGROUND OF THE INVENTION

The invention relates to a motion estimation method and apparatus.

In digital video and/or video/audio systems such as video-telephone, teleconference and digital television systems, a large amount of digital data is needed to define each video frame signal since a video line signal in the video frame signal comprises a sequence of digital data referred to as pixel values.

Since, however, the available frequency bandwidth of a conventional transmission channel is limited, in order to transmit the large amount of digital data therethrough, it is necessary to compress or reduce the volume of data through the use of various data compression techniques.

One of such techniques for encoding video signals for a low bit-rate encoding system is an object-oriented analysis-synthesis coding technique, wherein an input video image is divided into objects and three sets of parameters for defining the motions, the contours, and the pixel data of each object are processed through different encoding channels.

One example of such object-oriented coding scheme is the so-called MPEG (Moving Picture Experts Group) phase 4 (MPEG-4), which is designed to provide an audio-visual coding standard for allowing content-based interactivity, improved coding efficiency and/or universal accessibility in such applications as low-bit rate communications, interactive multimedia (e.g., games, interactive TV and the like) and surveillance (see, for instance, MPEG-4 Video Verification Model Version 2.0, International Organization for Standardization, ISO/IEC JTCl/SC29VWG11N1260, March 1996).

According to MPEG-4, an input video image is divided into a plurality of video object planes (VOP's), which correspond to entities in a bitstream that a user can have access to and manipulate. A VOP can be referred to as an object and represented by a bounding rectangle whose width and height may be chosen to be smallest multiples of 16 pixels (a macro block size) surrounding each object so that the encoder processes the input video image on a VOP-by-VOP basis, i.e., an object-by-object basis. The VOP includes color information consisting of the luminance component (Y) and the chrominance components (Cr, Cb) and contour information represented by, e.g., a binary mask.

Also, among various video compression techniques, the so-called hybrid coding technique, which combines temporal and spatial compression techniques together with a statistical coding technique, is known.

Most hybrid coding techniques employ a motion compensated DPCM Differential Pulse Coded Modulation), two-dimensional DCT (Discrete Cosine Transform), quantization of DCT coefficients, and VLC (Variable Length Coding). The motion compensated DPCM is a process of estimating the movement of an object between a current frame and its previous frame, and predicting the current frame according to the motion flow of the object to produce a differential signal representing the difference between the current frame and its prediction.

Specifically, in the motion compensated DPCM, current frame data is predicted from the corresponding previous frame data based on an estimation of the motion between the current and the previous frames. Such estimated motion may be described in terms of two dimensional motion vectors representing the displacements of pixels between the previous and the current frames.

There have been two basic approaches to estimate the displacements of pixels of an object. Generally, they can be classified into two types: one is a block-by-block estimation and the other is a pixel-by-pixel approach.

In the pixel-by-pixel approach, the displacement is determined for each and every pixel. This technique allows a more exact estimation of the pixel value and has the ability to easily handle scale changes and non-translational movements, e.g., scale changes and rotations, of the object. However, in the pixel-by-pixel approach, since a motion vector is determined at each and every pixel, it is virtually impossible to transmit all of the motion vectors to a receiver.

Using the block-by-block motion estimation, on the other hand, a current frame is divided into a plurality of search blocks. To determine a motion vector for a search block in the current frame, a similarity calculation is performed between the search block in the current frame and each of a plurality of equal-sized reference blocks included in a generally larger search region within a previous frame. An error function such as the mean absolute error or mean square error is used to carry out a similarity measurement between the search block in the current frame and the respective reference blocks in the search region of the previous frame. And the motion vector, by definition, represents the displacement between the search block and a reference block which yields a minimum error function.

As a search region, for example, a relatively large fixed-sized region around the search block might be used (the search block being in the center of the search region).

Another option is to—preliminary—predict the motion vector for a search block on the basis of one or several motion vectors from surrounding search blocks already—finally—determined, and to use as a search region, for example, a relatively small region not around the center of search block, but around the tip of the—preliminarily predicted—motion vector (the tip of the predicted motion vector being in the center of the search region).

### SUMMARY OF THE INVENTION

The invention is aimed at making available a novel motion estimation method, and a novel motion estimation apparatus.

A method for determining a motion vector for a current search block is provided, comprising the steps:
detecting the correlation between motion vectors determined for previous search blocks; and
depending on the detected correlation, either using a first, or a second search region for determining the motion vector for the current search block.

According to another aspect of the invention, an apparatus for determining a motion vector for a current search block is provided, comprising:
a correlation detector adapted for detecting the correlation between motion vectors determined for previous search blocks; and
a motion vector determinator adapted to use a first search region for determining the motion vector for the current search block if the detected correlation is below a predetermined threshold, and to use a second search region for determining the motion vector for the current search block if the detected correlation is above a predetermined threshold.

According to an embodiment of the invention, the first search region might be located around the center of the current search block, and the second search region might be located around the tip of a motion vector predicted for the current search block on the basis of motion vectors determined for previous search blocks.

### BRIEF DESCRIPTION OF THE DRAWINGS

The above and other features, aspects and advantages of the present invention will be more fully understood when considered with respect to the following detailed description, appended claims and accompanying drawings, wherein:

FIG. 1 shows an exemplifying, simplified block diagram of a current search block, several previous search blocks, and several previous motion vectors determined for the previous search blocks, where there is a relatively high correlation between the previous motion vectors;

FIG. 2 shows an exemplifying, simplified block diagram of a current search block, several previous search blocks, and several previous motion vectors determined for the previous search blocks, where there is a relatively low correlation between the previous motion vectors;

FIG. 3 shows an exemplifying, simplified block diagram of a search region, and a current search block, in the case of a relatively high correlation between the previous motion vectors, as e.g. shown in FIG. 1;

FIG. 4 shows an exemplifying, simplified block diagram of a search region, and a current search block, in the case of a relatively low correlation between the previous motion vectors, as e.g. shown in FIG. 2;

FIG. 5 shows a flow chart of procedural steps performed in a motion estimation method/algorithm according to an exemplifying embodiment of the invention; and

FIG. 6 shows a flow chart of procedural steps performed in a motion estimation method/algorithm according to a further exemplifying embodiment of the invention.

### DETAILED DESCRIPTION OF THE INVENTION

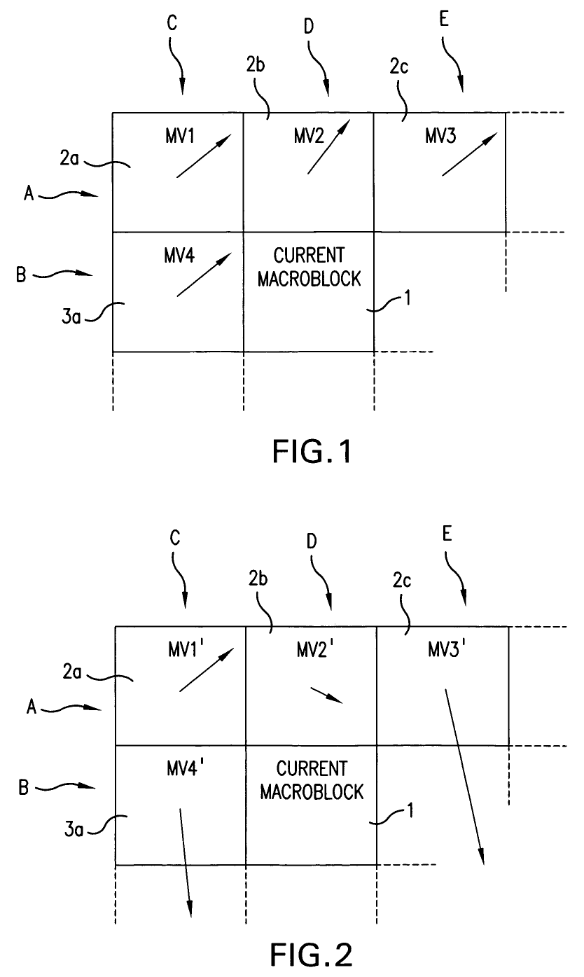

In the following, exemplifying embodiment of the invention, a block-by-block motion estimation is used, where a current frame—as shown in FIGS. 1 and 2—is divided into a plurality of search blocks 1, 2a, 2b, 2c, 3a (“macroblocks”).

FIG. 1 shows a simplified block diagram of a current search block 1, several previous search blocks 2a, 2b, 2c, 3a, and several motion vectors MV1, MV2, MV3, MV4 determined for the previous search blocks 2a, 2b, 2c, 3a, where—as will be described in further detail below—there is a relatively high correlation between the previous motion vectors MV1, MV2, MV3, MV4.

In contrast, FIG. 2 shows a simplified block diagram of a current search block 1, several previous search blocks 2a, 2b, 2c, 3a, and several motion vectors MV1′, MV2′, MV3′, MV4′ determined for the previous search blocks 2a, 2b, 2c, 3a, where—as will be described in further detail below—the correlation between the previous motion vectors MV1′, MV2′, MV3′, MV4′ is relatively low.

As is shown in FIGS. 1 and 2, respective motion vectors MV1, Mv2, MV3, MV4, MV1′, MV2′, MV3′, MV4′ e.g. might be subsequently determined first for the search blocks 2a, 2b, 2c comprised in a first (e.g. top) row A of search blocks 2a, 2b, 2c, than for the search blocks 3a, 1 comprised in an adjacent row B which might be—in a vertical direction—located below the first row A of search blocks 2a, 2b, 2c, etc., etc.

For each respective row A, B of search blocks 2a, 2b, 2c, 3a, 1, respective motion vectors MV1 , MV2, MV3, MV4, MV1′, MV2′, MV3′, MV4′ might be subsequently determined e.g. first for the search block 2a, 3a comprised in a first (e.g. left) column C of search blocks 2a, 3a, than for an adjacent search block 2b, I comprised in an adjacent column D which—in a horizontal direction—is located e.g. to the right of the first column C, etc., etc.

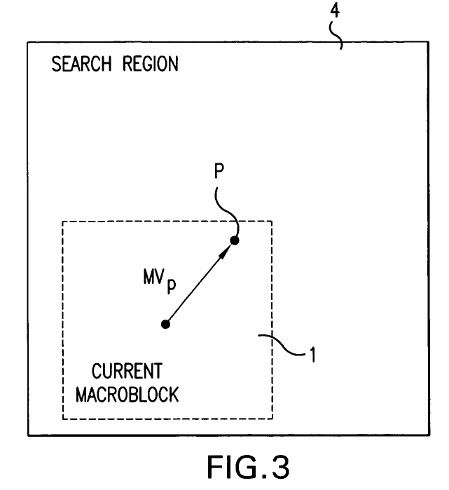

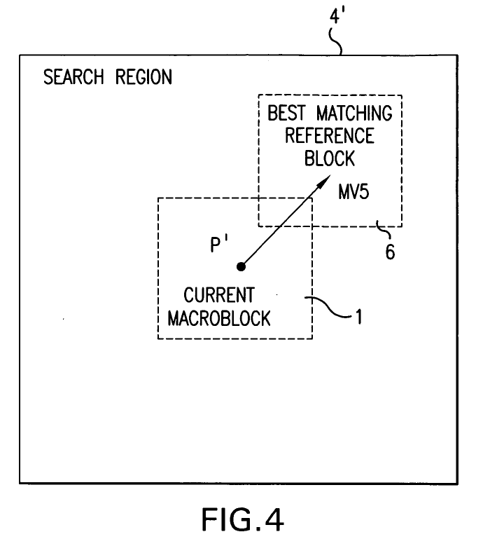

To determine a motion vector for a respective search block 2a, 2b, 2c, 3a, I in the current frame, a similarity calculation is performed between the search block 2a, 2b, 2c, 3a, 1 in the current frame and each of a plurality of equal-sized reference blocks included in a search region within a previous frame (see e.g. the search regions 4, 4′ shown in FIGS. 3 and 4).

Advantageously, the reference blocks have the same size, as the search blocks 2a, 2b, 2c, 3a, 1.

As will be described in further detail below, in the current embodiment, search regions 4, 4′ of different sizes might be used, depending on the detected correlation between previous motion vectors MV1, MV2, MV3, MV4, MV1′, MV2′, MV3′, MV4′ of previous search blocks (see e.g. the relatively small search region 4 used in the case of a relatively high correlation between the previous motion vectors MV1, MV2, MV3, MV4 as e.g. shown in FIG. 3, and e.g. the relatively big search region 4′ used in the case of a relatively low correlation between the previous motion vectors MV1′, MV2′, MV3′, MV4′ as e.g. shown in FIG. 4).

To determine a motion vector for a respective search block (e.g., a motion vector MV5 for the search block 1), an error function such as the mean absolute error or mean square error might be used to carry out the above similarity calculation between the search block I in the current frame and the respective reference blocks in the search region 4, 4′ of the previous frame.

The motion vector (e.g., the motion vector MV5 for the search block 1 as shown in FIG. 4), by definition, represents the displacement between the search block 1 and a reference block 6 which yields a minimum error function (e.g., the displacement between the search block 1, and a “best matching” reference block 6).

For the very first examined search block (e.g., the search block 2a shown in FIG. 1 or 2) (or e.g. for the first and second, or the first, second and third examined search blocks, e.g., the search blocks 2a, 2b and 2b shown in FIG. 1 or 2), a standard motion vector detection procedure might be applied, whereby, for example, as a search region, a relatively large fixed-sized region around the search block might be used, the search block being in the center of the search region (corresponding e.g. to what is shown in FIG. 4).

As will be described with respect to the search block I (“current macroblock”) shown in FIGS. 1 and 2 in further detail below, for the subsequently examined search blocks, the following, specific motion vector detection procedure might be applied:

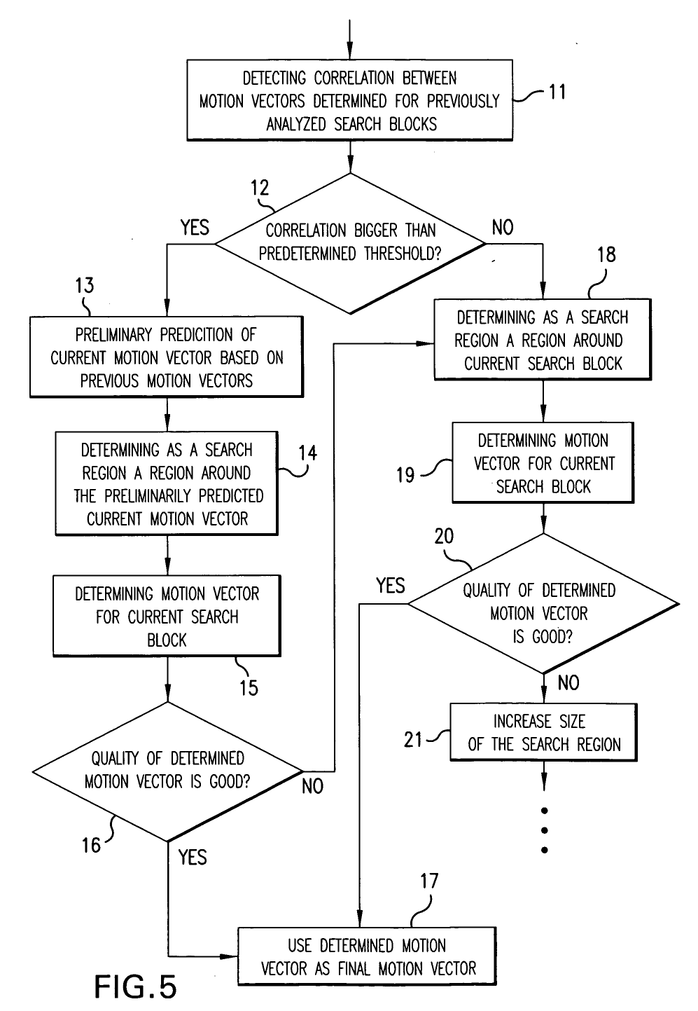

As is shown in FIG. 5, in a first step 11, the correlation between motion vectors MV1, MV2, MV3, MV4, MV1′, MV2′, MV3′, MV4′ determined for previously analyzed search blocks 2a, 2b, 2c, 3a is detected, e.g., the correlation between all of the motion vectors MV1, MV2, MV3, MV4, MV1′, MV2′, MV3′, MV4′ corresponding to search blocks 2a, 2b, 2c, 3a directly adjacent to the current search block 1 (see e.g. FIG. 1 and 2).

For calculating the correlation between the motion vectors MV1, MV2, MV3, MV4, MV1′, MV2′, MV3′, MV4′, e.g. the length and/or the direction of the motion vectors MV1, MV2, MV3, MV4, MV1′, MV2′, MV3′, MV4′ could be taken into account, and different, known correlation calculation methods could be applied (e.g., respective VAR-, SQRT(MSE)-methods, e.g. using an approximation of SQRT(MSE), etc. (MSE=Mean Square Error, SQR=Square Root)).

Further, instead of taking into account the—already calculated—motion vectors MV1, MV2, MV3, MV4, MV1′, MV2′, MV3′, MV4′ corresponding to search blocks 2a, 2b, 2c, 3a directly adjacent to the current search block 1, a different number of motion vectors could be taken into account, e.g., also—already calculated—motion vectors corresponding to search blocks not directly adjacent to the current search block 1 (e.g., motion vectors corresponding to search blocks directly adjacent to the above search blocks 2a, 2b, 2c, 3a adjacent to the current search block 1, etc., etc.).

In a variant,—when calculating the above motion vector correlation—the respective motion vectors MV1, MV2, MV3, MV4, MV1′, MV2′, MV3′, MV4′ might be weighted differently. For example, motion vectors MV1, MV2, MV3, MV4, MV1′, MV2′, MV3′, MV4′ corresponding to search blocks 2a, 2b, 2c, 3a adjacent to the current search block 1 might be weighted higher, than motion vectors corresponding to search blocks not adjacent to the current search block 1. Further, motion vectors MV2, MV4, MV2′, MV4′ corresponding to search blocks 2b, 3a horizontally or vertically adjacent to the current search block 1 might be weighted higher, than motion vectors MV1, MV3, MV1′, MV3′ corresponding to search blocks 2a, 2c diagonally adjacent to the current search block 1, etc., etc.

Thereafter, as is shown in FIG. 5, in a second step 12, the calculated value representing the correlation between the above motion vectors MV1, MV2, MV3, MV4, MV1′, MV2′, MV3′, MV4′ is compared with a predetermined threshold value.

If the value is bigger than the threshold, there is a relatively high correlation between the previous motion vectors (see e.g. the vectors MV1, MV2, MV3, MV4 shown in FIG. 1), and if the value is lower than the threshold, there is a relatively low correlation between the previous motion vectors (see e.g. the vectors MV1′, MV2′, MV3′, MV4′ shown in FIG. 2).

As is shown in FIG. 5, if there is a relatively high correlation between the previous motion vectors, i.e., if the determined correlation value is bigger then threshold (see e.g. the vectors MV1, MV2, MV3, MV4 shown in FIG. 1), a—preliminary—prediction for the motion vector for the current search block 1 is carried out (i.e.,—as is shown in FIG. 3—a predicted motion vector MVp is calculated).

Such prediction might e.g. be carried out on the basis of one or several motion vectors MV1, MV2, MV3, MV4 from surrounding search blocks already—finally—determined (e.g.,—again—on the basis of motion vectors MV1, MV2, MV3, MV4 corresponding to search blocks 2a, 2b, 2c, 3a directly adjacent to the current search block 1, or on the basis of a different number of motion vectors, e.g.—in addition—on the basis of—already calculated—motion vectors corresponding to search blocks not directly adjacent to the current search block 1 (e.g., motion vectors corresponding to search blocks directly adjacent to the above search blocks 2a, 2b, 2c, 3a adjacent to the current search block 1), etc., etc.).

When calculating the—preliminary—prediction for the motion vector for the current search block 1 (i.e., the predicted motion vector MVp), again, the respective motion vectors MV1, MV2, MV3, MV4 taken into account might be weighted differently. For example, motion vectors MV1, MV2, MV3, MV4 corresponding to search blocks 2a, 2b, 2c, 3a directly adjacent to the current search block 1 might be weighted higher, than motion vectors corresponding to search blocks not directly adjacent to the current search block. 1, etc., etc.

Thereafter, according to FIG. 5, and as is illustrated in FIG. 3, in a step 14, a search region 4 is determined, the center of which not (or not necessarily) being in the center of the current search block 1.

Instead, according to FIG. 3, the determined search region 4 is located around the tip of the—preliminarily predicted—motion vector MVp (the tip of the predicted motion vector MVp being in the center of the search region 4 (in other words, the predicted motion vector MVp serves as an “anchor” for the search region 4)).

Further, as already mentioned above, and as is illustrated in FIGS. 3 and 4, the search region 4 used in the case of a relatively high correlation between the previous motion vectors MV1, MV2, MV3, MV4 (as e.g. shown in FIG. 3) might be relatively small (in particular, smaller than a search region 4′ used in the case of a relatively low correlation between the previous motion vectors MV1′, MV2′, MV3′, MV4′ (as e.g. shown in FIG. 4)).

Thereafter, as is shown in FIG. 5, in a step 15, and using the above—small—search region 4, a motion vector for the current search block I is detected. Thereby, a convential error function such as the mean absolute error or mean square error might be used, and a similarity calculation between the search block 1 in the current frame and the respective reference blocks in the search region 4 of the previous frame is performed.

As said above, the motion vector determined represents the displacement between the search block 1 and a reference block which yields a minimum error function (e.g., the displacement between the search block 1, and a “best matching” reference block).

As is shown in FIG. 5, in a next step 16, it might be determined whether the quality, in particular, a “predicted bit cost” of the determined motion vector is (relatively) good or (relatively) bad, e.g. by comparing the above (minimum) error function of the “best matching” reference block corresponding to the determined motion vector with a predetermined threshold value. This threshold value could e.g. be a function of quantizer, working point,etc.

If the (minimum) error function is smaller, than the threshold value (i.e., if the quality, in particular, the “predicted bit cost” of the determined motion vector is relatively good), the determined motion vector is used as a final motion vector for the current search block 1 (see e.g. step 17 shown in FIG. 5).

However, if the (minimum) error function of the “best matching” reference block corresponding to the determined motion vector is bigger, than the threshold value (i.e., if the quality, in particular, the “predicted bit cost” of the determined motion vector is relatively bad), a further motion vector detection might be carried out using a different search region (e.g., as is shown in FIG. 5, a step 18 might be carried out, and corresponding steps 19, 20, etc., which will be described in further detail below).

Thereby, for example, as is shown in FIG. 4, a search region 4′ around the current search block 1 might be used (which might be bigger, than the search region 4)—or, alternatively, e.g., again a search region around the preliminary predicted motion vector MVp, but of a bigger size, than the search region 4 shown in FIG. 3.

Referring again to FIG. 5, if in the above step 12 it is detected that there is a relatively low correlation between the previous motion vectors (i.e., if the determined correlation value is smaller then the above threshold value (see e.g. the vectors MV1′, MV2′, MV3′, MV4′ shown in FIG. 2)), in a step 18, a search region 4′ is determined, the center of which—as is shown in FIG. 4—being located in the center of the current search block 1 (other than is the case for the search region 4 shown in FIG. 3, and used in the case of a relatively high correlation between the previous motion vectors).

Further, as already mentioned above, and as is illustrated in FIGS. 3 and 4, the search region 4′ used in the case of a relatively low correlation between the previous motion vectors MV1′, MV2′, MV3′, MV4′ (as e.g. shown in FIG. 4) might be relatively big (in particular, bigger than the search region 4 used in the case of a relatively high correlation between the previous motion vectors MV1, MV2, MV3, MV4 (as e.g. shown in FIG. 3)).

Thereafter, as is shown in FIG. 5, in a step 19, and using the above—big—search region 4′, a motion vector MV5 for the current search block 1 is detected. Thereby, a convential error function such as the mean absolute error or mean square error might be used, and a similarity calculation between the search block 1 in the current frame and the respective reference blocks in the search region 4′ of the previous frame is performed.

As said above, the motion vector MV5 determined represents the displacement between the search block 1 and a reference block which yields a minimum error function (e.g., the displacement between the search block 1, and a “best matching” reference block, here: e.g. the reference block 6 shown in FIG. 4).

As is shown in FIG. 5, in a next step 20, it might be determined whether the quality, in particular, the “predicted bit cost” of the determined motion vector MV5 is (relatively) good or (relatively) bad, e.g. by comparing the above (minimum) error function of the “best matching” reference block 6 corresponding to the determined motion vector with a predetermined threshold value.

If the (minimum) error function is smaller, than the threshold value (i.e., if the quality, in particular, quality the “predicted bit cost” of the determined motion vector MV5 is relatively good), the determined motion vector MV5 is used as a final motion vector for the current search block 1 (corresponding to the above step 17 shown in FIG. 5).

However, if the (minimum) error function of the “best matching” reference block 6 corresponding to the determined motion vector MV5 is bigger, than the threshold value (i.e., if the quality, in particular, the “predicted bit cost” of the determined motion vector is relatively bad), a further motion vector detection might be carried out using a different search region, in particular,—according to step 21 shown in FIG. 5—a search region, which is bigger than the search region 4′ shown in FIG. 4 (for example, a “full search” might be carried out, using—different from what was said above—the whole previous frame as a search region), etc.

In a variant, a process control tool might be used, which checks the currently available process resources on a chip (micro-processor) used to carry out a software program which when executed performs the above motion estimation method/algorithm according to the exemplifying embodiments of the invention, in particular, the above steps 11—21, or corresponding steps, etc.

When the process control tool determines that currently, quite a lot (or quite little) process resources are available, this information might be used as an input for the above algorithm, so as to adapt the algorithm correspondingly. For example, a lower threshold value might be used for the above step 12, if quite a lot of process resources are available (and a higher threshold value might be used, if quite little process resources are available), etc.

In addition, e.g., the size of the search regions 4, 4′ determined in steps 14, 18 as well might be chosen depending on the determined currently available process resources. For example, quite big search regions 4, 4′ might be used for the above steps 14, 18, if quite a lot of process resources are available (and quite small search regions 4, 4′ might be used for the above steps 14, 18, if quite little process resources are available), etc.

The sizes of the search regions 4, 4′ might also be chosen dependent on movie statistics, the current working point, etc., etc.

Further, for example, the size of the search region 4 determined in the above step 14 (and/or the size of the search region 4′ determined in the above step 19) might be chosen in accordance with previous “pass” rates in previously carried out motion vector quality, in particular, “predicted bit cost” determination steps 16 (and/or 20).

For example, if for a relatively high number/percentage of previously examined motion vectors it was—in the above step 16 (or 20)—detected that their quality, in particular, “predicted bit cost” is good, the size of the search region 4 (and/or the size of the search region 4′) might—in future—be reduced.

Correspondingly, if for a relatively low number/percentage of previously examined motion vectors it was—in the above step 16 (or 20)—detected that their quality, in particular, “predicted bit cost” is good, the size of the search region 4 (and/or the size of the search region 4′) might—in future—be increased, etc., etc.

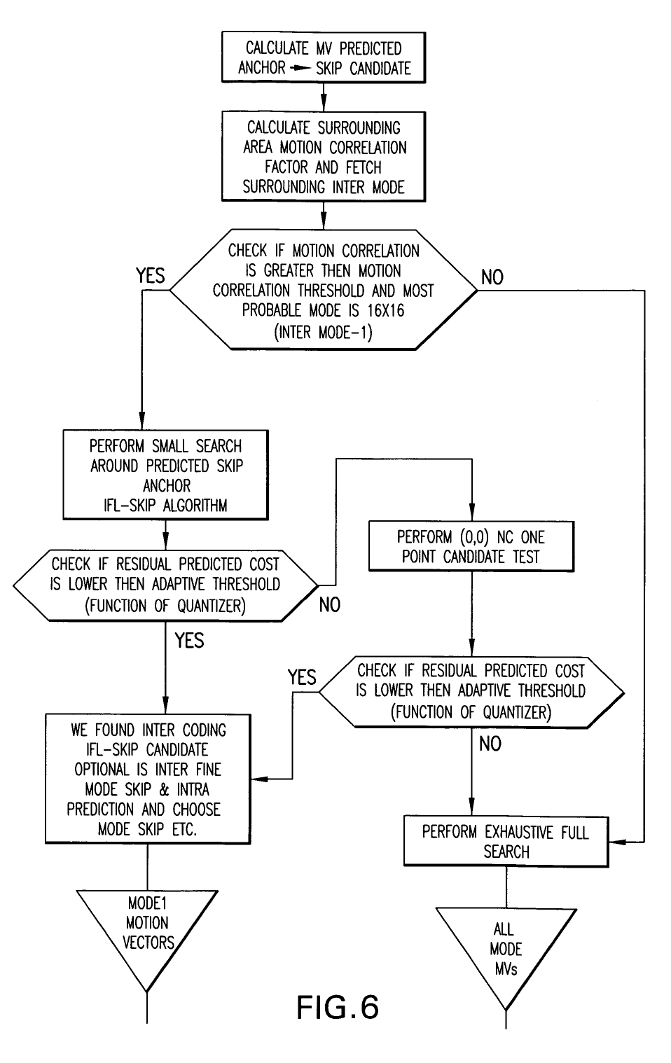

In FIG. 6, there is shown a flow chart of procedural steps performed in a motion estimation method/algorithm according to a further exemplifying embodiment of the invention, similar to that described with respect to FIG. 5 above.

By way of example, for both the procedures shown in FIG. 5, and in FIG. 6, MPEG2 technology with a full D1, 720×480, IBBP GOP structure might be used. Further, for example,—in both cases—the size of a “small” search region might e.g. be 3×3 pixels (with half pixel resolution), and the size of a “big” search region e.g. 160×128 pixels (with 2 pixel resolution in horizontal direction, and 1 pixel resolution in vertical direction).

In addition, by way of example, for detecting the above correlation factor, a standard SAD calculation might be applied.

While certain examplary embodiments have been described in detail and shown in the accompanying drawings, it is to be understood that such embodiments are merely illustrative of and not restrictive on the broad invention. It will thus be recognized that various modifications may be made to the illustrated and other embodiments of the invention, without departing from the scope and spirit of the invention as defined by the appended claims.

1. A method for determining a motion vector for a current search block, comprising the steps:
detecting the correlation between motion vectors determined for previous search blocks; and
depending on the detected correlation, either using a first, or a second search region for determining the motion vector for the current search block.

2. The method of claim 1, wherein the first search region is located around the center of the current search block.

3. The method of claim 1, wherein the second search region is located around the tip of a motion vector predicted for the current search block on the basis of motion vectors determined for previous search blocks.

4. The method of claim 1, wherein the first search region is bigger, than the second search region.

5. The method of claim 1, further comprising the step: detecting the quality, in particular, the predicted bit cost of the determined motion vector for the current search block.

6. The method of claim 5, wherein, if the detected quality, in particular, predicted bit cost is relatively low, again a motion vector is determined for the current search block, using a bigger search region.

7. The method of claim 5, wherein, if the detected quality, in particular, predicted bit cost is relatively low, again a motion vector is determined for the current search block, using a search region located around the center of the current search block.

8. The method of claim 5, wherein the size of a first or a second search region used for a succeeding search block is determined depending on the detected quality, in particular, predicted bit cost of the determined motion vector for the current search block.

9. The method of claim 1, wherein the size of the first or the second search region is determined depending on currently available process resources on a processor.

10. An apparatus for determining a motion vector for a current search block, comprising:
a correlation detector adapted for detecting the correlation between motion vectors determined for previous search blocks;
a motion vector determinator adapted to use a first search region for determining the motion vector for the current search block if the detected correlation is below a predetermined threshold, and to use a second search region for determining the motion vector for the current search block if the detected correlation is above a predetermined threshold.

11. The apparatus of claim 10, wherein the first search region is located around the center of the current search block, and the second search region is located around the tip of a motion vector predicted for the current search block on the basis of motion vectors determined for previous search blocks.
